(19) United States
(12) Patent Application Publication
(10) Pub. No.: US 2025/0183729 A1
(43) Pub. Date: Jun. 5, 2025

(54) Techniques for Wireless Charging Negotiation

(71) Applicant: Apple Inc., Cupertino, CA (US)

(72) Inventors: Brandon R. Garbus, San Diego, CA (US); Daniel Ye, San Francisco, CA (US)

(21) Appl. No.: 18/444,562

(22) Filed: Feb. 16, 2024

Related U.S. Application Data
(60) Provisional application No. 63/605,945, filed on Dec. 4, 2023.

(51) Int. Cl. H02J 50/80; H02J 50/12; H02J 50/60

(52) U.S. Cl. CPC H02J 50/80; H02J 50/12; H02J 50/60

(57) ABSTRACT

A wireless power transfer system may include a power transmitting device for transferring wireless power to a power receiving device. During communications with the power receiving device, the power receiving device can measure a frequency of the digital pings and, based on a result of the measured frequency, report a selected wireless charging standard version or identification number to the power transmitting device.

This application claims the benefit of U.S. Provisional Patent Application No. 63/605,945, filed Dec. 4, 2023, which is hereby incorporated by reference herein in its entirety.

### Field

This relates generally to power systems, and, more particularly, to wireless power systems for charging electronic devices.

### BACKGROUND

In a wireless charging system, a wireless power transmitting device such as a charging pad can transmit wireless power to a wireless power receiving device such as a battery-powered, portable electronic device. The wireless power transmitting device has a coil that produces electromagnetic flux. The wireless power receiving device has a coil and a rectifier that uses electromagnetic flux produced by the transmitter to generate direct-current power that can be used to power electrical loads in the battery-powered, portable electronic device.

The wireless power transmitting device can transmit wireless power to the wireless power receiving device in accordance with a wireless charging standard. It can be challenging to design a wireless power receiving device that can be charged by different wireless power transmitting devices operating based on different versions of the wireless charging standard and/or different wireless charging standards. If care is not taken, the wireless power transmitting and receiving devices may not interoperate.

### SUMMARY

An aspect of the disclosure provides an electronic device that includes a wireless power transfer coil configured to receive digital pings from a wireless power transmitting device, a rectifier coupled to the wireless power transfer coil, measurement circuitry coupled to the wireless power transfer coil and configured to measure a frequency of the digital pings, and control circuitry. The control circuitry can include one or more processors and/or transceiver circuitry configured to convey a first wireless charging standard version number to the wireless power transmitting device in response to determining that the measured frequency of the digital pings is within a frequency range and configured to convey a second wireless charging standard version number, different than the first wireless charging standard version number, to the wireless power transmitting device in response to determining that the measured frequency of the digital pings is outside the frequency range.

An aspect of the disclosure provides a method of operating an electronic device that includes receiving, at a wireless power transfer coil, digital pings from a wireless power transmitting device, measuring a frequency of the digital pings, determining whether the measured frequency of the digital pings is in a frequency range, and conveying a first wireless charging protocol identification number to the wireless power transmitting device in response to determining that the measured frequency of the digital pings is in the frequency range. The method can further include conveying a second wireless charging protocol identification number, different than the first wireless charging protocol identification number, to the wireless power transmitting device in response to determining that the measured frequency of the digital pings is not in the frequency range. The first wireless charging protocol identification number and the second wireless charging protocol identification number can be conveyed to the wireless power transmitting device by transmitting a protocol identification packet via the wireless power transfer coil using amplitude-shift keying (ASK) modulation or other modulation scheme. The first and second wireless charging protocol identification numbers can represent different versions of a wireless charging standard such as the Qi wireless charging protocol/standard.

An aspect of the disclosure provides a method of operating an electronic device that includes receiving ping signals, at a coil, from a wireless power transmitting device, measuring a frequency of the ping signals, determining whether the measured frequency of the ping signals is in a first frequency range, and determining whether the measured frequency of the ping signals is in a second frequency range. The method can further include conveying a first wireless charging standard version number to the wireless power transmitting device in response to determining that the measured frequency of the ping signals is in the first frequency range, conveying a second wireless charging standard version number, different than the first wireless charging standard version number, to the wireless power transmitting device in response to determining that the measured frequency of the ping signals is in the second frequency range, conveying a third wireless charging standard version number, different than the first and second wireless charging standard version numbers, to the wireless power transmitting device in response to determining that the measured frequency of the ping signals is outside the first and second frequency ranges.

### BRIEF DESCRIPTION OF THE DRAWINGS

FIG. 1 is a diagram of an illustrative wireless power transfer system that includes a wireless power transmitting device and a wireless power receiving device in accordance with some embodiments.

FIG. 2 is a diagram showing wireless power transmitting and receiving circuitry and associated wireless data transceiver circuitry in accordance with some embodiments.

FIG. 3 is a flow chart of illustrative steps for operating a wireless power transfer system of the type shown in FIGS. 1 and 2 in accordance with some embodiments.

FIG. 4 is a diagram showing how a wireless charging standard version number can be identified by determining whether a measured frequency is within a first frequency range in accordance with some embodiments.

FIG. 5 is a diagram showing how a wireless charging standard version number can be identified by determining whether a measured frequency is within a second frequency range in accordance with some embodiments.

FIG. 6 is a diagram showing how a wireless charging standard version number can be identified by determining whether a measured frequency is within a first frequency range or a second frequency range in accordance with some embodiments.

### DETAILED DESCRIPTION

A wireless power transfer system includes a wireless power transmitting device and a wireless power receiving device. The wireless power transmitting device can transmit wireless power to the wireless power receiving device. Wireless power receiving devices may include electronic devices such as wristwatches, cellular telephones, tablet computers, laptop computers, ear buds, battery cases for ear buds and other devices, tablet computer styluses (pencils) and other input-output devices, wearable devices, head-mounted devices, glasses, or other electronic equipment. The wireless power transmitting device may be an electronic device such as a wireless charging mat or puck, a tablet computer or other battery-powered electronic device with wireless power transmitting circuitry, or other wireless power transmitting device. The wireless power receiving devices use the wireless power received from the wireless power transmitting device for powering internal components and for charging an internal battery. Because transmitted wireless power is often used for charging internal batteries, wireless power transmission operations are sometimes referred to as wireless charging operations.

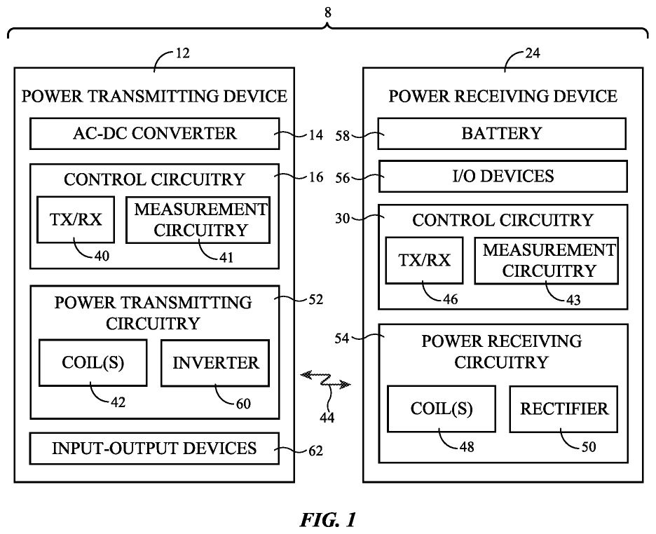

An illustrative wireless power transfer system 8, sometimes referred to as a wireless charging system, is shown in FIG. 1. As shown in FIG. 1, system 8 includes a wireless power transmitting device such as wireless power transmitting device 12 and includes a wireless power receiving device such as wireless power receiving device 24. Wireless power transmitting device 12 can include control circuitry 16, whereas wireless power receiving device 24 can include control circuitry 30. Control circuitry in system 8 such as control circuitry 16 and control circuitry 30 is used in controlling the operation of system 8. Such control circuitry may include processing circuitry associated with microprocessors, power management units, baseband processors, application processors, digital signal processors, microcontrollers, and/or application-specific integrated circuits with processing circuits.

The processing circuitry implements desired control and communications features in devices 12 and 24. For example, the processing circuitry may be used in selecting coils, determining power transmission levels, processing sensor data and other data, processing user input, handling negotiations between devices 12 and 24, sending and receiving in-band and out-of-band data, making measurements, and otherwise controlling the operation of system 8. As another example, the processing circuitry may include one or more processors such as an application processor that is used to run software such as internet browsing applications, voice-over-internet-protocol (VOIP) telephone call applications, email applications, media playback applications, operating system functions, power management functions for controlling when one or more processors wake up, game applications, maps, instant messaging applications, payment applications, calendar applications, notification/reminder applications, etc.

Control circuitry in system 8 may be configured to perform operations in system 8 using hardware (e.g., dedicated hardware or circuitry), firmware and/or software. Software code for performing operations in system 8 is stored on non-transitory computer readable storage media (e.g., tangible computer readable storage media) in control circuitry 8. The software code may sometimes be referred to as software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 30. The processing circuitry may include application-specific integrated circuits with processing circuitry, one or more microprocessors such as an application processor, a central processing unit (CPU) or other processing circuitry.

Wireless power transmitting device 12 may be a stand-alone power adapter (e.g., a wireless charging mat or puck that includes power adapter circuitry), may be a wireless charging mat or puck that is coupled to a power adapter or other equipment by a cable, may be a battery-powered electronic device (cellular telephone, tablet computer, laptop computer, removable case, etc.), may be equipment that has been incorporated into furniture, a vehicle, or other system, or may be other wireless power transfer equipment. Illustrative configurations in which wireless power transmitting device 12 is a wireless charging puck or battery-powered electronic device are sometimes described herein as an example.

Wireless power receiving device 24 may be a portable electronic device such as a wristwatch, a cellular telephone, a laptop computer, a tablet computer, an accessory such as an earbud, a tablet computer input device such as a wireless tablet computer stylus (pencil), a battery case, a wearable device, a head-mounted device, glasses, or other electronic equipment. Wireless power transmitting device 12 may be coupled to a wall outlet (e.g., an alternating current power source), may have a battery for supplying power, and/or may have another source of power. Device 12 may have an alternating-current (AC) to direct-current (DC) power converter such as AC-DC power converter 14 for converting AC power from a wall outlet or other power source into DC power. In some configurations, AC-DC power converter 14 may be provided in an enclosure (e.g., a power brick enclosure) that is separate from the enclosure of device 12 (e.g., a wireless charging puck enclosure or battery-powered electronic device enclosure) and a cable may be used to couple DC power from the power converter to device 12. DC power may be used to power control circuitry 16.

During operation, a controller in control circuitry 16 may use power transmitting circuitry 52 to transmit wireless power to power receiving circuitry 54 of device 24. Power transmitting circuitry 52 may have switching circuitry (e.g., inverter circuitry 60 formed from transistors) that is turned on and off based on control signals provided by control circuitry 16 to create AC current signals through one or more wireless power transfer coils 42. Coils 42 may be arranged in a planar coil array (e.g., in configurations in which device 12 is a wireless charging mat) or may be arranged to form a cluster of coils (e.g., in configurations in which device 12 is a wireless charging puck). In some arrangements, device 12 (e.g., a charging mat, pad, puck, battery-powered device, etc.) may have only a single wireless power transfer coil. In other arrangements, wireless charging device 12 may have multiple coils (e.g., two or more coils, 5-10 coils, at least 10 coils, 10-30 coils, fewer than 35 coils, fewer than 25 coils, or other suitable number of coils).

As the AC currents pass through one or more coils 42, the coils 42 produce corresponding electromagnetic field 44 in response to the AC current signals. Electromagnetic field (sometimes referred to as wireless power or wireless power signals) 44 can then induce a corresponding AC current to flow in one or more nearby receiver coils such as coil 48 in power receiving device 24. Rectifier circuitry such as a rectifier 50, which contains rectifying components such as synchronous rectification metal-oxide-semiconductor transistors arranged in a bridge network, can convert the induced AC current flowing through coil 48 into DC voltage signals for powering one or more loads in power receiving device 24 such powering application processors as well as charging a battery in device 24. This principle of wireless power transfer can be referred to as the transmitting and receiving of wireless power or wireless power signals.

The DC voltages produced by rectifier 50 can be used in powering an energy storage device such as battery 58 and can be used in powering other components in power receiving device 24. For example, device 24 may include input-output devices 56 such as a display, touch sensor, communications circuits, audio components, sensors, components that produce electromagnetic signals that are sensed by a touch sensor in a tablet computer or other device with a touch sensor (e.g., to provide stylus (pencil) input, etc.), and other components, and these components may be powered by the DC voltages produced by rectifier 50 (and/or DC voltages produced by battery 58 or other energy storage device in device 24). Wireless power transmitting device 12 may also include one or more input-output devices 62 (e.g., input devices and/or output devices of the type described in connection with input-output devices 56) or input-output devices 62 may be omitted (e.g., to reduce device complexity).

Control circuitry 16 in power transmitting device 12 can include transceiver circuitry 40 and measurement circuitry 41. Measurement circuitry 41 can be configured to detect external objects on the charging surface of the housing of device 12 (e.g., on the top of a charging pad or, if desired, to detect objects adjacent to the coupling surface of a charging pad). Measurement circuitry 41 is therefore sometimes referred to as external object measurement circuitry. The housing of device 12 may have polymer walls, walls of other dielectric, metal structures, fabric, and/or other housing wall structures that enclose coil(s) 42 and other circuitry of device 12. The charging surface may be a planer outer surface of the upper housing wall of device 12. Measurement circuitry 41 can detect foreign objects such as coils, paper clips, and other metallic objects and can detect the presence of wireless power receiving devices 24 (e.g., circuitry 41 can detect the presence of one or more coils 48). During object detection and characterization operations, external object measurement circuitry 41 can be used to make measurements on coil(s) 42 to determine whether any devices 24 are present on the charging surface of device 12.

Control circuitry 30 in power receiving device 24 can include transceiver circuitry 46 and measurement circuitry 43. Measurement circuitry 43 may include signal generator circuitry, pulse generator circuitry, signal detection circuitry, and other and/or measurement circuitry (e.g., circuitry of the type described in connection with circuitry 41 in control circuitry 16). Circuitry 41 and/or circuitry 43 may be used in making current and voltage measurements, measurements of transmitted and received power for power transmission efficiency estimates, coil Q-factor measurements, coil inductance measurements, coupling coefficient measurements, and/or other measurements. Based on this information or other information, control circuitry 30 can characterize the operation of devices 12 and 24. For example, measurement circuitry 41 can measure coil(s) 42 to determine the inductance(s) and Q-factor value(s) for coil(s) 42, can measure transmitted power in device 12 (e.g., by measuring the DC voltage powering inverter 60 and the DC current of inverter 60 and/or by otherwise measuring voltages and currents in the wireless power transmitting circuitry 52 of device 12), and can make other measurements on operating parameters associated with other components in device 12. In power receiving device 24, measurement circuitry 43 can measure coil(s) 48 to determine the inductance(s) and Q-factor value(s) for those coil(s), can measure received power in device 24 (e.g., by measuring the output current and output voltage Vrect of rectifier 50 and/or by otherwise measuring voltages and currents in wireless power receiving circuitry 54 of device 24), and can make other measurements on the operating parameters associated with other components in device 24.

During wireless power transfer operations, wireless transceiver (TX/RX) circuitry 40 can use one or more coils 42 to transmit in-band signals to wireless transceiver circuitry 46 that are received by wireless transceiver circuitry 46 using coil(s) 48. Suitable modulation schemes may support communications between power transmitting device 12 and power receiving device 24. With one illustrative configuration, frequency-shift keying (FSK) can be used to convey in-band data from device 12 to device 24 and amplitude-shift keying (ASK) can be used to convey in-band data from device 24 to device 12. As another example, FSK can be used to convey data in both directions between devices 12 and 24. As another example, ASK can be used to convey data in both directions between devices 12 and 24. Wireless power may be conveyed from device 12 to device 24 during these FSK/ASK transmissions. Other types of in-band communications may be used, if desired.

During wireless power transfer operations, power transmitting circuitry 52 supplies AC drive signals to one or more coils 42 at a given power transmission frequency (sometimes referred to as a carrier frequency, power carrier frequency, or drive frequency). The power carrier frequency may be, for example, a predetermined frequency of about 125 kHz, about 128 kHz, about 200 kHz, about 326 kHz, about 360 kHz, at least 80 kHz, at least 100 kHz, less than 500 kHz, less than 300 kHz, 1.78 MHz, 13.56 MHz, or other suitable wireless power frequency. Devices operating under the Qi wireless charging standard established by the Wireless Power Consortium (WPC) generally operate between 110-205 kHz, between 80-300 kHz, or between 300-400 kHz. In some configurations, the power transmission frequency may be negotiated during startup communications between devices 12 and 24. In other configurations, the power transmission frequency can be fixed.

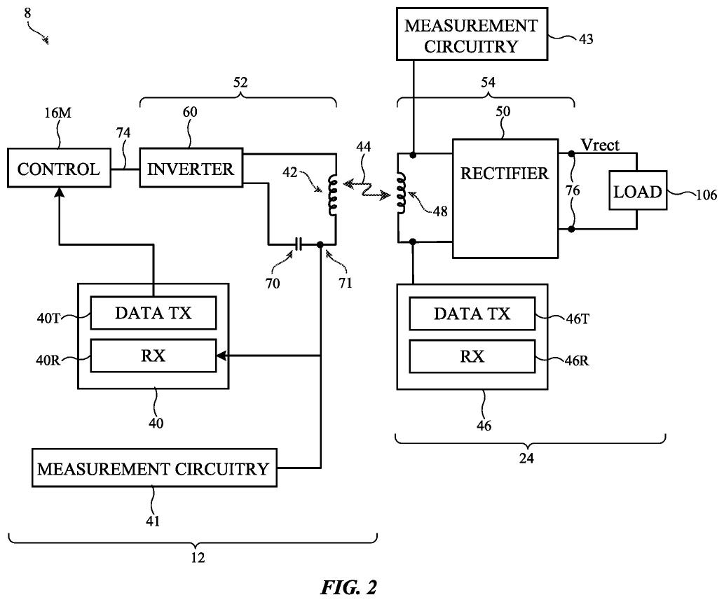

FIG. 2 is a diagram showing wireless power transmitting and receiving circuitry and associated wireless data transceiver circuitry in devices 12 and 24. Power transmitting circuitry 52 of device 12 may use inverter 60 or other driver for producing wireless power signals that are transmitted through an output circuit having one or more coil(s) 42 and capacitors such as capacitor 70. Control signals for inverter 60 are provided by control circuitry 16 at control input 74. A single coil 42 is shown in the example of FIG. 2, but multiple coils 42 may be used, if desired.

During wireless power transfer/transmission operations, transistors in inverter 60 are driven by AC control signals from control circuitry 16 (e.g., controller 16M supplies drive signals for inverter 60 at input 74 at a desired AC drive frequency). This causes the output circuit formed from coil 42 and capacitor 70 to produce alternating-current (AC) electromagnetic field (signals 44) that is received by wireless power receiving circuitry 54 formed from coil 48 in device 24. Rectifier 50 can then convert received power from AC to DC and supply a corresponding direct current (DC) output voltage Vrect across rectifier output terminals 76 for powering load 106 in device 24 (e.g., for charging battery 58, for powering a display and/or other input-output devices 56, and/or for powering other circuitry in load 106).

During wireless power transfer operations, while power transmitting circuitry 52 in device 12 is driving AC signals into coil 42 to produce signals 44 at the power transmission frequency, wireless transceiver circuitry 40 in device 12 can use frequency shift keying (FSK) modulation to modulate the power transmission frequency of the driving AC signals and thereby modulate the frequency of signals 44. As shown in FIG. 2, FSK modulator 40T may modulate the power transmission frequency that is being supplied by controller 16M to input 74 of inverter 60. Operated in this way, FSK data is transmitted in-band from device 12 to device 24. This data can be received in power receiving device 24 by using FSK demodulator 46R (data receiver RX) to perform FSK demodulation operations.

In power receiving device 24, coil 48 is used to receive signals 44. Power receiving circuitry 54 in device 24 uses the received signals on coil 48 and rectifier 50 to produce DC power. At the same time, wireless transceiver circuitry 46 (e.g., FSK demodulator 46R) in device 24 uses FSK demodulation to extract the transmitted in-band data from signals 44. This approach allows FSK data (e.g., FSK data packets) to be transmitted in-band from device 12 to device 24 with coils 42 and 48 while wireless power is simultaneously being conveyed from device 12 to device 24 via coils 42 and 48. Transceiver circuitry 46 may be coupled to coil 48 (e.g., via one or more capacitors). Measurement circuitry 43 may also be coupled to coil 48 or some other node in power receiving circuitry 54 to make impedance measurements, impulse response measurements, or other desired measurements for external object detection.

Such in-band communications between device 24 and device 12 can also use ASK modulation and demodulation techniques. Wireless transceiver circuitry 46 includes ASK modulator 46T coupled to coil 48 to modulate the impedance of power receiving circuitry 54 (e.g., to adjust the impedance at coil 48). This, in turn, modulates the amplitude of signals 44 and the amplitude of the AC signals passing through coil 42. ASK demodulator 40R monitors the amplitude of the AC signal passing through coil 42 and, using ASK demodulation, extracts the transmitted in-band data from these signals that was transmitted by wireless transceiver circuitry 46. ASK demodulator 40R may be coupled to a node 71 between coil 42 and capacitor 70 or may be coupled to some other node in power transmitting circuitry 52. Similarly, measurement circuitry 41 may optionally be coupled to node 71 or some other node in power transmitting circuitry 52 to make impedance measurements, impulse response measurements, or other desired measurements for external object detection. The use of ASK communications allows ASK data bits (e.g., ASK data packets) to be transmitted in-band from device 24 to device 12 via coils 48 and 42 while wireless power is simultaneously being conveyed from device 12 to device 24 via coils 42 and 48.

Power transmitting device 12 may transmit wireless power to power receiving device 24 in accordance with one or more wireless charging (interface) standards. As an example, device 12 may convey wireless power to device 24 in accordance with the Qi wireless charging standard developed by the Wireless Power Consortium (WPC). As another example, device 12 may convey wireless power to device 24 in accordance with the Power Matters Alliance (PMA) wireless charging standard. As another example, device 12 may convey wireless power to device 24 in accordance with the IEEE 802.11 wireless charging standard developed by the Wi-Fi Alliance. These examples are illustrative. If desired, other wireless charging interface standards or protocols can be employed. Wireless power transfer operations in which device 12 conveys wireless power to device 24 based on the Qi standard are sometimes described herein as an example.

Each wireless charging standard (protocol) can have many versions or revisions as the standard is being updated over time. As examples, Qi version 1.0 (sometimes referred to as Qi1) was released in 2010; Qi version 1.1 (sometimes referred to as Qi1.1) was released in 2012; Qi version 1.2 (sometimes referred to as Qi1.2) was released in 2015; Qi version 1.2.3 (sometimes referred to as Qi1.2.3) was released in 2017; Qi version 1.3 (sometimes referred to as Qi1.3) was released in 2021; and Qi version 2.0 (sometimes referred to as Qi2) was released in 2023. The various versions (version numbers) can exhibit different maximum power transfer capabilities, different foreign object detection capabilities, different timing specifications, different authentication specifications, different alignment and mounting requirements, and/or other differing restrictions/constraints on the wireless power transfer operations.

It can be challenging to design a wireless power receiving device operable to be charged by various wireless power transmitting devices operating based on different versions of a wireless charging standard. Consider a scenario in which a power receiving device is placed on the charging surface of a power transmitting device. The power transmitting device may be expecting to receive, during startup operations, a Qi protocol identification packet reporting a specific version number. If, however, the power transmitting device receives a Qi protocol identification packet that reports a version number different than the expected version number, the power transmitting device can be programmed to automatically shut down without charging the power receiving device.

To address this problem, power receiving device 24 can be configured to measure a frequency during digital ping operations and to report, back to power transmitting device 12, a selected wireless charging standard version number based on the measured frequency. Such frequency based selection and reporting of version number solves the problem because power transmitting devices operated based on different versions of a wireless charging standard can exhibit different digital ping frequencies. Thus, configuring and operating a power receiving device 24 in this way can be technically advantageous and beneficial to identify or differentiate between power transmitting devices 12 operated using different versions of a wireless charging standard (e.g., different versions of the Qi protocol) and to send an appropriate protocol identification packet back to the power transmitting device, thus preventing the power transmitting device from inadvertently shutting down prior to wireless power transfer operations.

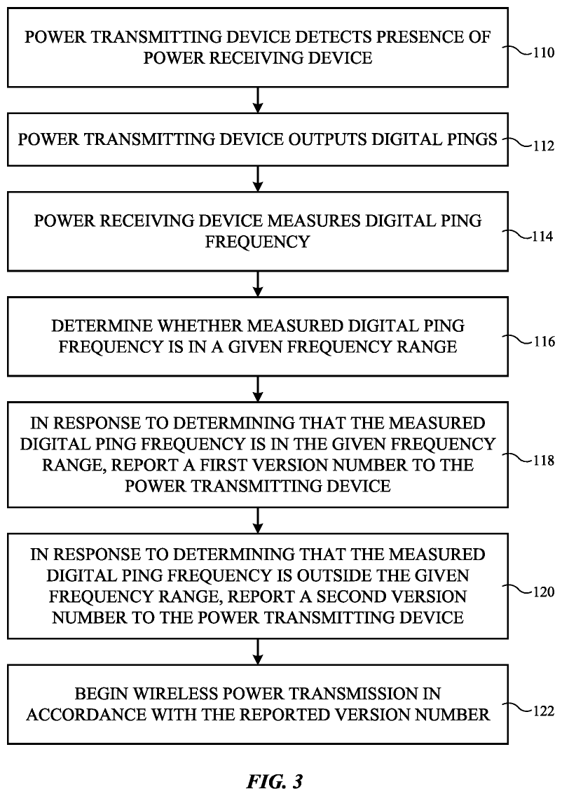

FIG. 3 is a diagram showing illustrative steps for operating system 8 of the type described in connection with FIGS. 1 and 2. During the operations of block 110, power transmitting device 12 can operate in a foreign object detection (FOD) mode and can detect the presence of a power receiving device 24 on its charging surface. As an example, power transmitting device 12 may use low-power external object detection or analog pings to detect the presence of a foreign object. As another example, power transmitting device 12 may perform impedance measurements, impulse response measurements, or other suitable foreign object detection schemes to detect when device 24 has been placed on the charging surface of device 12.

After power transmitting device 12 detects a potential power receiving device 24 on its charging surface, device 12 can output, during the operations of block 112, digital pings to communicate with device 24. Digital pings are a type of ping signals. “Digital pings” may refer to and be defined herein as signals having longer pulses than the external object detection analog pings and having sufficient energy to activate or wake power receiving device 24 (e.g., the digital pings have sufficient bandwidth to support in-band communications between devices 12 and 24). For example, FSK and/or ASK data packets may be conveyed between devices 12 and 24 during digital ping operations. These communications can be modulated at a carrier frequency such as the operating frequency used to provide wireless power during active wireless power transfer mode. Devices operating under the Qi wireless charging standard established by the Wireless Power Consortium generally operate between 110-205 kHz or 80-300 kHz. Frequencies of about 125 kHz, about 128 kHz, about 200 kHz, about 326 kHz, about 360 kHz, at least 80 kHz, at least 100 kHz, less than 500 kHz, less than 300 kHz, 1.78 MHz, 13.56 MHz, or other suitable wireless power frequency are also possible. The frequency being used to modulate the digital pings can be referred to and defined herein as a “digital ping frequency.”

Different implementations of Qi might dictate use of different digital ping frequencies. During the operations of block 114, power receiving device 24 can measure the digital ping frequency. Power receiving device 24 can measure the digital ping frequency using measurement circuitry 43 (e.g., by monitoring a signal waveform at coil 48).

During the operations of block 116, device 24 can determine whether the measured digital ping frequency obtained from block 114 is in a given (or predetermined) frequency range. A “frequency range” can refer to and be defined herein as a single frequency value, two or more discrete frequency values, or a set of frequency values bounded by a lower frequency limit and an upper frequency limit. In general, one or more processors within control circuitry 30 of device 24 can compare the measured digital ping frequency with one or more ranges of frequencies.

During the operations of block 118, device 24 may report a first wireless charging standard version number to power transmitting device 12 in response to determining that the measured digital ping frequency is in (within) the given frequency range. In examples where frequency range represents a single frequency value, device 24 may determine whether the measured digital ping frequency is equal to or matches the single frequency value. In examples where frequency range represents two or more discrete (different) frequency values, device 24 may determine whether the measured digital ping frequency is equal to or matches one of the multiple discrete frequency values. The frequency range can include one or more discrete frequency values selected from 128 kHz, 326 kHz, 360 kHz, 1.78 MHz, and 13.56 M Hz. In examples where frequency range represents a set of frequency values bounded by a lower frequency limit and an upper frequency limit, device 24 may determine whether the measured digital ping frequency is in the set of frequency values (e.g., by determining that the measured frequency is greater than or equal to the lower frequency limit and less than or equal to the upper frequency limit). The wireless charging standard version number is sometimes referred to as a wireless charging protocol identification number. The wireless charging standard version number can be included as part of a protocol identification (ID) packet that is transmitted from device 24 to device 12 via in-band communications (e.g., device 24 can transmit an ASK data packet that includes the first wireless charging protocol identification number to device 12).

During the operations of block 120, device 24 may report a second wireless charging standard version number, different than the first wireless charging standard version number, to power transmitting device 12 in response to determining that the measured digital ping frequency is outside the given frequency range. In examples where frequency range represents a single frequency value, device 24 may determine whether the measured digital ping frequency is not equal to or mismatched from the single frequency value. In examples where frequency range represents two or more discrete frequency values, device 24 may determine whether the measured digital ping frequency is not equal to any of the multiple discrete frequency values. In examples where frequency range represents a set of frequency values bounded by a lower frequency limit and an upper frequency limit, device 24 may determine whether the measured digital ping frequency is not within the set of frequency values (e.g., by determining that the measured frequency is less the lower frequency limit or greater than the upper frequency limit). The wireless charging standard version number is sometimes referred to as a wireless charging protocol identification number. The wireless charging standard version number can be included as part of a protocol identification (ID) packet that is transmitted from device 24 to device 12 via in-band communications (e.g., device 24 can transmit an ASK data packet that includes the second wireless charging protocol identification number to device 12).

In FIG. 3, although the operations of block 120 are shown as occurring after the operations of block 118, either the operations of block 118 or the operations of block 120 are performed depending on the comparison result from block 116. In other words, if the measured digital ping frequency is within the given frequency range, then the operations of block 118 are performed without performing the operations of block 120 (e.g., block 120 is skipped). Else (if the measured digital ping frequency is outside the given frequency range), then the operations of block 120 are performed without performing the operations of block 118 (e.g., block 118 is skipped).

During the operations of block 122, power transmitting device 12 can begin transmitting wireless power to power receiving device 24. In other words, power transmitting device 12 may operate in an active wireless power transfer mode. Power transmitting device 12 can begin transmitting wireless power in accordance with the reported version number in the protocol identification packet received from device 24 during the operations of block 118 or block 120. Newer version numbers can generally support higher wireless power transfer capabilities (e.g., higher power transfer rates). During the active wireless power transfer mode, device 12 may concurrently perform in-band communications with device 24 (e.g., device 12 may use data transmitter 40T to transmit FSK packets to data receiver 46R, whereas device 24 may use data transmitter 46T to transmit ASK packets to data receiver 40R while wireless power is being transferred from device 12 to device 24).

The power transmitting device 12 may be operated in the active wireless power transfer mode to charge battery 58 of device 24 until a state of charge (SOC) of battery 58 is deemed to be full. Power transfer operations can be halted when the state of charge of battery 58 has exceeded a target charging threshold, when the temperature of battery 58 has exceeded a predetermined temperature threshold, or when device 12 otherwise determines that power transmission should be halted. The target charging threshold may, for example, be equal to 80%, 90%, 95%, 99%, or other suitable target threshold value for indicating that battery 58 is near the end of charge or is fully charged. Pausing or halting power transfer operations when battery 58 is fully charged can help reduce power consumption at device 12 while preventing unnecessary charging at device 24 (e.g., constantly topping off battery 58 to 100% state of charge may be excessive especially when device 24 is idle).

The operations of FIG. 3 are illustrative. Operating system 8 in this way can be technically advantageous and beneficial to differentiate between power transmitting devices 12 operated using different versions of a wireless charging standard (e.g., different versions of Qi) and to send an appropriate protocol identification packet back to the power transmitting device, thus preventing power transmitting device 12 from shutting down prior to wireless power transfer operations. In some embodiments, one or more of the described operations may be modified, replaced, or omitted. In some embodiments, one or more of the described operations may be performed in parallel. In some embodiments, additional processes may be added or inserted between the described operations. If desired, the order of certain operations may be reversed or altered and/or the timing of the described operations may be adjusted so that they occur at slightly different times. In some embodiments, the described operations may be distributed in a larger system.

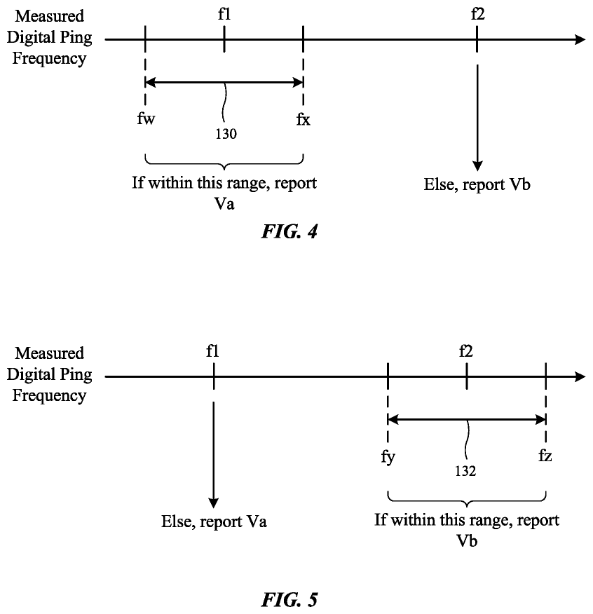

FIG. 4 is a diagram illustrating how a wireless charging standard version number can be identified by determining whether a measured digital ping frequency is within a first frequency range. In the example of FIG. 4, a power transmitting device of a first type (e.g., a power transmitting device operating in accordance with a first wireless charging standard version number Va) may output digital pings at a first frequency f1, whereas a power transmitting device of a second type (e.g., a power transmitting device operating in accordance with a second wireless charging standard version number Vb) may output digital pings at a second frequency f2. In this example, if the measured digital ping frequency is within a first frequency range 130 from fw to fx, where frequency f1 is between fw and fx, then power receiving device 24 may, in response, report version number Va back to the power transmitting device. Else (if the measured digital ping frequency is not within the frequency range 130, then power receiving device 24 may report version number Vb to the power transmitting device.

As an example, frequency f1 might be equal to 128 kHz, whereas frequency f2 might be equal to 145 kHz. In this example, the first frequency range 130 that includes frequency f1 of 128 kHz may range from 122 kHz to 134 kHz, 123 kHz to 133 kHz, 124 kHz to 132 kHz, 118 kHz to 138 kHz, or other suitable frequency range surrounding f1. The wireless charging standard version number Va that is reported by device 24 when the measured digital ping frequency is within the first frequency range might be version 2.0 or 2.x of the Qi protocol (as an example), where version 2.x represents newer version of Qi-all referred to collectively as version 2 of Qi. The wireless charging standard version number Vb that is report by device 24 when the measured digital ping frequency is outside the first frequency range 130 might be version 1.x of the Qi protocol, where version number 1.x can represent version 1.1, 1.2, 1.3, or other older version of the Qi protocol-all referred to collectively as version 1 of Qi. The number in front of the first (leftmost) decimal represents the major version number, whereas the number(s) after the first decimal represents the minor version number. This is exemplary. Version 1.x of the Qi protocol can also cover all editorial versions 1.x.y under Qi version 1.x. Similarly, version 2.x of the Qi protocol can also cover all editorial versions 2.x.y under Qi version 2.x. In general, frequencies f1 and f2 can be in the kHz or MHz range, and version numbers Va and Vb can represent different version numbers or identifiers associated with any wireless charging standard/protocol.

The example of FIG. 4 in which the wireless charging standard version number is determined based on a comparison of the measured digital ping frequency against a range including frequency f1 is illustrative. FIG. 5 is a diagram illustrating how a wireless charging standard version number can be identified by determining whether a measured digital ping frequency is within a second frequency range including frequency f2. In this example, if the measured digital ping frequency is within a second frequency range 132 from fy to fz, where frequency f2 is between fy and fz, then power receiving device 24 may, in response, report version number Vb back to the power transmitting device. Else (if the measured digital ping frequency is not within the frequency range 132, then power receiving device 24 may report version number Va to the power transmitting device.

As an example, frequency f1 might be equal to 128 kHz, whereas frequency f2 might be equal to 145 kHz. In this example, the second frequency range 132 that includes frequency f2 of 145 kHz may range from 139 kHz to 151 kHz, 140 kHz to 150 Hz, 141 kHz to 149 Hz, 135 kHz to 155 kHz, or other suitable frequency range surrounding f2. The wireless charging standard version number Vb that is reported by device 24 when the measured digital ping frequency is within the second frequency range might be version 1.x of the Qi protocol (as an example), version number 1.x can represent version 1.2, 1.3, or other older version of the Qi protocol. The wireless charging standard version number Va that is report by device 24 when the measured digital ping frequency is outside the second frequency range 132 might be version 2.0 or 2.x of the Qi protocol, where version 2.x can represent 2.0 or newer versions of the Qi protocol. This is exemplary. In general, frequencies f1 and f2 can be in the kHz or MHz range, and version numbers Va and Vb can represent different version numbers or identifiers associated with any wireless charging standard/protocol.

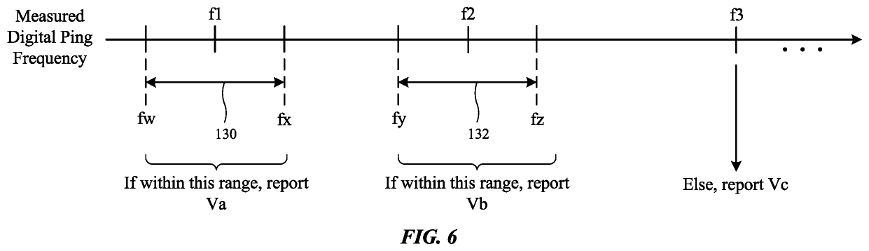

The example of FIG. 4 in which the wireless charging standard version number is determined based on comparison with a first frequency range 130 around f1 and the example of FIG. 5 in which the wireless charging standard version number is determined based on comparison with a second frequency range 132 around f2 are illustrative. In general, power receiving device 24 may be configured to identify the wireless charging standard version number by comparing the measured digital ping frequency with one or more frequency ranges. FIG. 6 is a diagram showing how the wireless charging standard version number can be identified by determining whether the measured frequency is within first frequency range 130 and/or whether the measured frequency is within second frequency range 132 in accordance with some embodiments.

As shown in FIG. 6, if the measured digital ping frequency is within frequency range 130, then device 24 can report version number Va back to the power transmitting device during startup operations prior to the active wireless power transfer mode. Else if the measured digital ping frequency is within frequency range 132, then device 24 can report version number Vb back to the power transmitting device during the startup operations prior to the active wireless power transfer mode. Else if the measured digital ping frequency is outside both frequency ranges 130 and 132 (e.g., if the measured frequency is not within range 130 and not within range 132), then device 24 can a report a third version number Ve back to the power transmitting device during the startup operations prior to the active wireless power transfer mode. The third version number Vc may be associated with a power transmitting device that outputs digital pings at frequency f3. In general, frequencies f1, f2, and f3 can be in the kHz or MHz range, and version numbers Va, Vb, and Vc can represent different version numbers or identifiers associated with any wireless charging standard/protocol. Although FIG. 6 shows f1<f2<f3, frequency f1 can optionally be greater than f2 and/or f3, and frequency f3 can optionally be less than f2 and/or f1. If desired, this approach can be extended to any number of digital ping frequencies and wireless charging standard versions.

The foregoing is merely illustrative and various modifications can be made to the described embodiments. The foregoing embodiments may be implemented individually or in any combination.

What is claimed is:

1. An electronic device comprising:
a wireless power transfer coil configured to receive digital pings from a wireless power transmitting device;
a rectifier coupled to the wireless power transfer coil;
measurement circuitry coupled to the wireless power transfer coil and configured to measure a frequency of the digital pings; and
control circuitry configured to:
in response to determining that the measured frequency of the digital pings matches a frequency value or is within a frequency range, convey a first wireless charging standard version number to the wireless power transmitting device; and
in response to determining that the measured frequency of the digital pings is mismatched from the frequency value or is outside the frequency range, convey a second wireless charging standard version number, different than the first wireless charging standard version number, to the wireless power transmitting device.

2. The electronic device of claim 1, wherein the control circuitry is further configured to convey the first wireless charging standard version number or the second wireless charging standard version number to the wireless power transmitting device by transmitting a protocol identification packet that includes the first wireless charging standard version number or the second wireless charging standard version number to the wireless power transmitting device via the wireless power transfer coil.

3. The electronic device of claim 2, wherein the wireless power transfer coil is configured to start receiving wireless power from the wireless power transmitting device after transmitting the protocol identification packet to the wireless power transmitting device in accordance with the transmitted wireless charging standard version number.

4. The electronic device of claim 1, wherein the frequency value and the frequency range comprises 128 kHz, wherein the first wireless charging standard version number comprises version 2.x of Qi, and wherein the second wireless charging standard version number comprises version 1.x of Qi.

5. The electronic device of claim 4, wherein the control circuitry is further configured to negotiate another wireless charging frequency with the power transmitter device after operating for a time at the frequency value or the frequency range, wherein the another wireless charging frequency is mismatched from the frequency value or is outside the frequency range.

6. The electronic device of any one of claim 4 or 5, wherein the frequency range is between 118 kHz and 138 kHz.

7. The electronic device of claim 1, wherein the frequency value and the frequency range comprises 145 kHz, wherein the first wireless charging standard version number comprises version 1.x of Qi, and wherein the second wireless charging standard version number comprises version 2.x of Qi.

8. The electronic device of claim 7, wherein the frequency range is between 135 kHz and 155 kHz.

9. A method of operating an electronic device, comprising:
with a wireless power transfer coil, receiving digital pings from a wireless power transmitting device;
measuring a frequency of the digital pings;
determining whether the measured frequency of the digital pings is in a frequency range; and
in response to determining that the measured frequency of the digital pings is in the frequency range, conveying a first wireless charging protocol identification number to the wireless power transmitting device.

10. The method of claim 9, further comprising:
in response to determining that the measured frequency of the digital pings is not in the frequency range, conveying a second wireless charging protocol identification number, different than the first wireless charging protocol identification number, to the wireless power transmitting device.

11. The method of claim 10, further comprising:
conveying the first wireless charging protocol identification number or the second wireless charging protocol identification number to the wireless power transmitting device by transmitting a protocol identification packet via the wireless power transfer coil.

12. The method of claim 11, wherein transmitting the protocol identification packet comprises transmitting the protocol identification packet using amplitude-shift keying (ASK) modulation.

13. The method of claim 11, further comprising:
after transmitting the protocol identification packet, beginning to receive wireless power from the wireless power transmitting device for charging a battery in the electronic device.

14. The method of claim 10, wherein the first and second wireless charging protocol identification numbers comprise different versions of a wireless charging standard.

15. The method of claim 10, wherein the frequency range is between 118 kHz to 138 kHz, and wherein the first wireless charging protocol identification number comprises version 2.x of Qi.

16. The method of claim 15, wherein the second wireless charging protocol identification number comprises version 1.x of Qi.

17. The method of claim 10, wherein the frequency range comprises a single frequency value selected from 128 kHz, 326 kHz, 360 kHz, 1.78 MHz, and 13.56 MHz.

18. The method of claim 10, wherein the frequency range comprises multiple discrete frequency values selected from 128 kHz, 326 kHz, 360 kHz, 1.78 MHz, and 13.56 MHz.

19. A method of operating an electronic device, comprising:
with a wireless power transfer coil, receiving ping signals from a wireless power transmitting device;
measuring a frequency of the ping signals;
determining whether the measured frequency of the ping signals is in a first frequency range;
determining whether the measured frequency of the ping signals is in a second frequency range; and
in response to determining that the measured frequency of the ping signals is in the first frequency range, conveying a first wireless charging standard version number to the wireless power transmitting device.

20. The method of claim 19, further comprising:
in response to determining that the measured frequency of the ping signals is in the second frequency range, conveying a second wireless charging standard version number, different than the first wireless charging standard version number, to the wireless power transmitting device.

21. The method of claim 20, further comprising:
in response to determining that the measured frequency of the ping signals is outside the first and second frequency ranges, conveying a third wireless charging standard version number, different than the first and second wireless charging standard version numbers, to the wireless power transmitting device.

22. The method of claim 21, further comprising:
conveying the first wireless charging standard version number, the second wireless charging standard version number, or the third wireless charging standard version number to the wireless power transmitting device by transmitting a protocol identification packet via the coil.
